(19) United States
(12) Patent Application Publication
(10) Pub. No.: US 2007/0008334 A1
(43) Pub. Date: Jan. 11, 2007

(54) Motion compensation display

(75) Inventor: Kesatoshi Takeuchi, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/431,523

(22) Filed: May 11, 2006

(30) Foreign Application Priority Data
Jul. 5, 2005 (JP) 2005-195664

(51) Int. Cl. G09G 5/02

(52) U.S. Cl. 345/589; 375/240.12; 375/240.26

(57) ABSTRACT

In an image display apparatus of the invention, a motion area detection module sequentially detects a motion area in each of frame images sequentially displaced by an image display device. A motion compensation module performs motion compensation for the detected motion area of each frame image, generates drive image data with a result of the motion compensation, and outputs the drive image data to actuate the image display device. A luminance adjustment module eliminates a luminance difference between the detected motion area and a stationary area in each frame image, which is ascribed to a decrease in luminance of the motion area relative to a luminance of the stationary area due to the motion compensation by the motion compensation module and potentially arises in the frame image displayed by the image display device. This arrangement of the invention enables effective motion compensation without requiring a large-scale processing circuit for generation of interpolated frame images.

### BACKGROUND OF THE INVENTION

1. Field of the Invention

The present invention relates to a motion compensation display technique to enable smooth display of a moving picture by an image display apparatus using flat panels, for example, liquid crystal panels as an image display device.

2. Description of the Related Art

An image display apparatus including an image display device, such as a liquid crystal panel, sequentially changes over multiple frame images at a preset frame rate to display a moving image. This causes relatively intermittent motions of the displayed moving image.

A motion compensation technique has been proposed to generate interpolated frame images that interpolate two continuous existing frame images and accordingly attain a smooth display of a moving image (see, for example, Japanese Patent Laid-Open Gazette No. 10-233996, No. 2003-524949, and No. 2003-69961).

This motion compensation technique, however, requires a significantly large-scale processing circuit for generation of the interpolated frame images, which includes memories, operation circuits, and diversity of other digital circuits. The interpolated frame images often have relatively insufficient picture quality.

### SUMMARY OF THE INVENTION

The object of the invention is thus to eliminate the drawbacks of the prior art technique and to provide a technique of attaining effective motion compensation without a significantly large-scale processing circuit for generation of interpolated frame images, which includes memories, operation circuits, and diversity of other digital circuits.

In order to attain at least part of the above and the other related objects, the present invention is directed to a first image display apparatus including: an image display device that sequentially displays frame images expressed by sequentially input frame image data; a motion area detection module that sequentially detects a motion area in each of the sequentially displayed frame images; a motion compensation module that performs motion compensation for the detected motion area of each frame image, generates drive image data with a result of the motion compensation, and outputs the drive image data to actuate the image display device; and a luminance adjustment module that eliminates a luminance difference between the detected motion area and a stationary area in each frame image, which is ascribed to a decrease in luminance of the motion area relative to a luminance of the stationary area due to the motion compensation by the motion compensation module and potentially arises in the frame image displayed by the image display device.

The motion compensation module has: an image memory; and a drive image data generation module that replaces at least part of read image data corresponding to the detected motion area, out of read image data sequentially read from the image memory, with mask data and generates the drive image data including the replaced mask data.

In the first image display apparatus of the invention, the motion compensation module replaces at least part of the read image data corresponding to the detected motion area with mask data. Such replacement with the mask data effectively compensates for a motion in the motion area by taking advantage of the characteristics of the human vision. This motion compensation technique does not require the conventional large-scale processing circuit for generation of interpolated frame images. The luminance adjustment module effectively eliminates the luminance difference between the detected motion area and the stationary area in each frame image, which is ascribed to the decrease in luminance of the motion area relative to the luminance of the stationary area due to the motion compensation and potentially arises in the frame image displayed by the image display device.

In one preferable embodiment of the image display apparatus of the invention, the luminance adjustment module has: a luminance adjustment device that works to eliminate the luminance difference; and a luminance adjustment data generation module that generates drive data for lowering a luminance of image light corresponding to the stationary area, out of image light emitted from the image display device to represent an image, to eliminate the luminance difference in each frame image and outputs the generated drive data to actuate the luminance adjustment device.

In the image display apparatus of this embodiment, the luminance adjustment data generation module controls the luminance adjustment device to readily eliminate the luminance difference between the motion area and the stationary area.

In one preferable structure of this embodiment, the image display apparatus further includes: a light source that emits illumination light for illuminating the image display device; and an emission control module that regulates an emission level of the light source. The emission control module increases the emission level of the light source to compensate for the lowered luminance of the image light corresponding to the stationary area by the luminance adjustment device, when the image displayed by the image display device has the motion area.

The image display apparatus of this structure increases the emission level of the light source, which emits the illumination light for illuminating the image display device, to compensate for the lowered luminance of the image light corresponding to the stationary area by the luminance adjustment device. This arrangement effectively relieves the decrease in luminance of the image due to the luminance adjustment.

In another preferable embodiment of the image display apparatus of the invention, the motion compensation module specifies a pixel value of the mask data corresponding to a motion amount of the detected motion area and performs the motion compensation with the mask data of the specified pixel value. The luminance adjustment module eliminates the luminance difference, while preventing a significant decrease in luminance corresponding to the motion amount.

This arrangement enables effective motion compensation according to the motion amount of the detected motion area.

The present invention is also directed to a second image display apparatus including: an image display device that sequentially displays frame images expressed by sequentially input frame image data; a motion area detection module that sequentially detects a motion area in each of the sequentially displayed frame images; a motion compensation module that performs motion compensation for the detected motion area of each frame image, generates drive image data with a result of the motion compensation, and outputs the drive image data to actuate the image display device; and a luminance adjustment module that eliminates a luminance difference between the detected motion area and a stationary area in each frame image, which is ascribed to a decrease in luminance of the motion area relative to a luminance of the stationary area due to the motion compensation by the motion compensation module and potentially arises in the frame image displayed by the image display device.

The motion compensation module has: an image memory; a write control module that sequentially writes frame image data, which are successively input at a preset frame rate, into the image memory; a read control module that reads the frame image data ‘s’ times from the image memory at a specific rate of ‘s’ times the frame rate, where ‘s’ represents an integer of not less than 2, with regard to each frame image data written in the image memory; and a drive image data generation module that replaces at least part of read image data corresponding to the detected motion area, out of read image data sequentially read from the image memory, with mask data and generates the drive image data including the replaced mask data.

The second image display apparatus of the invention has the similar functions and effects to those of the first image display apparatus described above.

The technique of the invention is not restricted to the image display apparatus having any of the above arrangements but may also be actualized by an image data processing device, a corresponding image display method, or a corresponding image data processing method. There are diversity of other applications of the invention, for example, computer programs that are used to attain the image display apparatus, the image data processing device, and the corresponding methods, recording media in which such computer programs are recorded, and data signals that include such computer programs and are embodied in carrier waves.

In the applications of the invention as the computer programs and the recording media in which the computer programs are recorded, the invention may be given as a whole program to control the operations of the image display apparatus or as a partial program to exert only the characteristic functions of the invention. Available examples of the recording media include flexible disks, CD-ROMs, DVD-ROMs and DVD-RAMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 is a block diagram schematically illustrating the configuration of an image display apparatus in a first embodiment of the invention;

FIG. 2 shows one concrete arrangement of a luminance adjustment device included in the image display apparatus of FIG. 1;

FIG. 3 is a block diagram showing the structure of a motion area detection module included in the image display apparatus of FIG. 1;

FIG. 4 shows one example of table data stored in a mask parameter specification unit and a luminance parameter specification unit included in the motion area detection module of FIG. 3;

FIG. 5 is a block diagram showing the structure of a drive image data generation module included in the image display apparatus of FIG. 1;

FIG. 6 is a block diagram showing the structure of a mask data generation unit included in the drive image data generation module of FIG. 5;

FIG. 7 shows one example of drive image data generated by the drive image data generation module of FIG. 5;

FIG. 8 shows motion areas of first drive image data DFI1(N) and second drive image data DFI2(N) generated corresponding to frame image data FR(N) of an N-th frame;

FIG. 9 shows motion areas of first drive image data DFI1(N+1) and second drive image data DFI2(N+1) generated corresponding to frame image data FR(N+1) of an (N+1)-th frame;

FIG. 10 is a block diagram showing the structure of a luminance adjustment data generation module included in the image display apparatus of FIG. 1;

FIG. 11 shows the effects of luminance adjustment;

FIG. 12 shows the effects of luminance adjustment;

FIG. 13 is a block diagram schematically illustrating the configuration of another image display apparatus in a second embodiment of the invention;

FIG. 14 shows the effects of luminance adjustment in the image display apparatus of the second embodiment; and

FIG. 15 shows one concrete arrangement of a reflective liquid crystal panel as the luminance adjustment device in one modified example.

### DESCRIPTION OF THE PREFERRED EMBODIMENTS

Some modes of carrying out the invention are described below as preferred embodiments in the following sequence with reference to the accompanied drawings:

A. First Embodiment

A1. General Configuration of Image Display Apparatus

A2. Detection of Motion Area

A3. Motion Compensation

A4. Effects of Motion Compensation

A5. Luminance Adjustment

A6. Effects of Luminance Adjustment

B. Second Embodiment

C. Modifications

### A. First Embodiment

A1. General Configuration of Image Display Apparatus

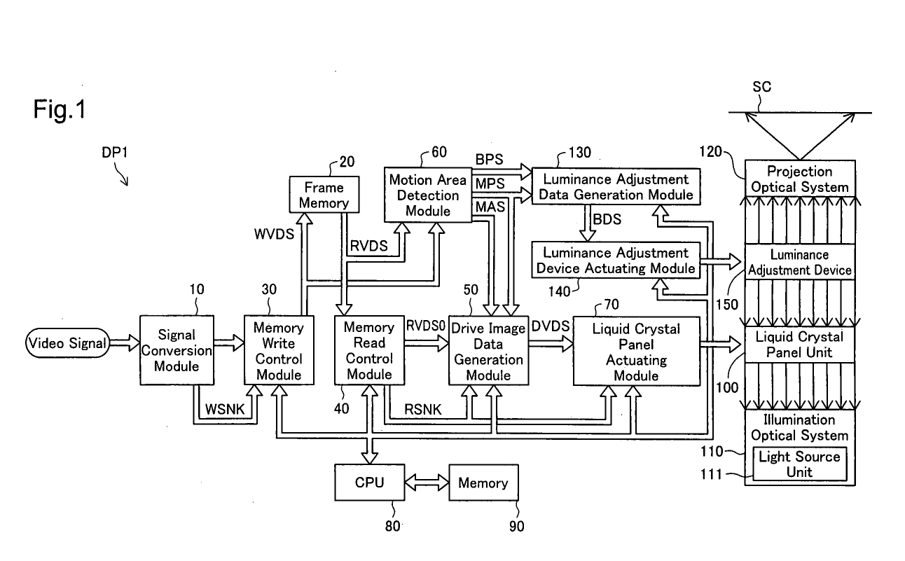

FIG. 1 is a block diagram schematically illustrating the configuration of an image display apparatus DP1 in a first embodiment of the invention. As illustrated, the image display apparatus DP1 has an image data processing system constructed as a computer system including a signal conversion module 10, a frame memory 20, a memory write control module 30, a memory read control module 40, a drive image data generation module 50, a motion area detection module 60, a liquid crystal panel actuating module 70, a luminance adjustment data generation module 130, a luminance adjustment device actuating module 140, a CPU 80, and a memory 90. The image display apparatus DP1 further includes external storage devices, interfaces, and diversity of other peripheral equipment generally included in the computer system, although they are omitted from the illustration.

The image display apparatus DP1 also has an image display system including a liquid crystal panel unit 100 as an image display device, an illumination optical system 110, a luminance adjustment device 150, and a projection optical system 120. The image display apparatus DP1 converts illumination light emitted from the illumination optical system 110 into image light representing an image by the functions of the liquid crystal panel unit 100. The image light enters the projection optical system 120 via the luminance adjustment device 150 and is focused as a projected image on a projection screen SC by the projection optical system 120. The liquid crystal panel actuating module 70 and the luminance adjustment device actuating module 140 may be regarded as functional blocks included in the image display system, instead of the image data processing system.

The CPU 80 reads out a control program and processing conditions stored in the memory 90 and executes the control program to control the operations of the respective functional blocks.

The signal conversion module 10 is a processing circuit to convert externally input video signals into signals processible by the memory write control module 30. For example, each input analog video signal is converted into a digital video signal synchronously with a synchronizing signal included in the input video signal. Each input digital video signal is converted into a signal form processible by the memory write control module 30.

The memory write control module 30 sequentially writes image data of respective frames included in the digital video signal output from the signal conversion module 10 into the frame memory 20, synchronously with a write synchronizing signal WSNK corresponding to the digital video signal. The write synchronizing signal WSNK includes a write vertical synchronizing signal, a write horizontal synchronizing signal, and a write clock signal.

The memory read control module 40 generates a read synchronizing signal RSNK based on read control conditions read from the memory 90 by the CPU 80, and reads out the image data written in the frame memory 20 synchronously with the read synchronizing signal RSNK. The memory read control module 40 then outputs a read image data signal RVDS0 representing the read-out image data and the generated read synchronizing signal RSNK to the drive image data generation module 50. The read synchronizing signal RSNK includes a read vertical synchronizing signal, a read horizontal synchronizing signal, and a read clock signal. The frequency of the read vertical synchronizing signal is set to be half the frequency (double frame rate) of the write vertical synchronizing signal of the video signal written in the frame memory 20. The memory read control module 40 reads out the image data written in the frame memory 20 in the units of frame images twice in one frame period and outputs the read-out image data as the read image data signal RVDS0 to the drive image data generation module 50.

The drive image data generation module 50 generates a drive image data signal DVDS for actuating the liquid crystal panel unit 100 via the liquid crystal panel actuating module 70, in response to the read image data signal RVDS0 and the read synchronizing signal RSNK supplied from the memory read control module 40 and a motion area data signal MAS and a mask parameter signal MPS (described below) supplied from the motion area detection module 60. The generated drive image data signal DVDS is output to the liquid crystal panel actuating module 70. The structure and the operations of the drive image data generation module 50 will be described later in detail.

The motion area detection module 60 specifies image data of each frame (hereafter may be referred to as ‘frame image data’) sequentially written in the frame memory 20 as an object of detection and detects a motion area of the specified frame image data relative to previous frame image data previously read from the frame memory 20. The motion area detection module 60 outputs a motion area data signal MAS representing the detected motion area to the drive image data generation module 50. A mask parameter MP specified according to a motion amount of the detected motion area is output as a mask parameter signal MPS to the drive image data generation module 50 and the luminance adjustment data generation module 130. A luminance parameter BP specified according to the motion amount of the detected motion area is output as a luminance parameter signal BPS to the luminance adjustment data generation module 130. The structure and the operations of the motion area detection module 60 will be described later in detail.

The liquid crystal panel actuating module 70 converts the drive image data signal DVDS supplied from the drive image data generation module 50 into a signal form suppliable to the liquid crystal panel unit 100 and supplies the converted drive image data signal to the liquid crystal panel unit 100.

The liquid crystal panel unit 100 converts illumination light emitted from the illumination optical system 110 into image light representing an image corresponding to the supplied drive image data signal and emits the image light.

The luminance adjustment data generation module 130 generates a luminance adjustment data signal BDS for actuating the luminance adjustment device 150 via the luminance adjustment device actuating module 140, in response to the mask parameter signal MPS and the luminance parameter signal BPS supplied from the motion area detection module 60. The generated luminance adjustment data signal BDS is output to the luminance adjustment device actuating module 140. The structure and the operations of the luminance adjustment data generation module 130 will be described later in detail.

The luminance adjustment device 150 adjusts the luminance of the image light emitted from the liquid crystal panel unit 100 based on the supplied luminance adjustment data signal BDS and outputs the image light of the adjusted luminance to the projection optical system 120.

The projection optical system 120 projects an image represented by the input image light onto the projection screen SC.

The liquid crystal panel unit 110, the luminance adjustment device 150, and the projection optical system 120 are arranged to satisfy the following positional relation.

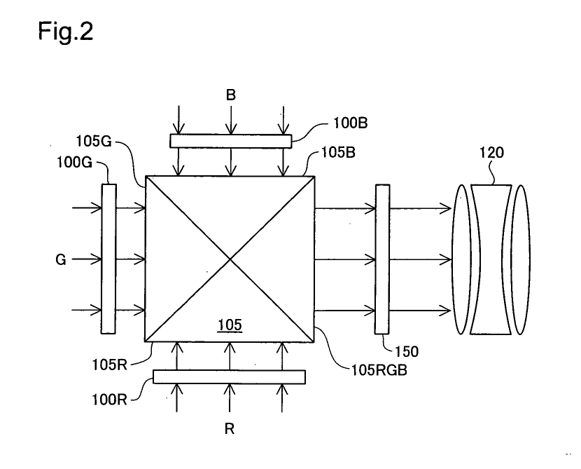

FIG. 2 shows one concrete arrangement of the luminance adjustment device 150.

The liquid crystal panel unit 100 includes a liquid crystal panel 100R for converting red (R) color illumination light into R color image light representing an image of a red (R) color component and emitting the R color image light, a liquid crystal panel 100G for converting green (G) color illumination light into G color image light representing an image of a green (G) color component and emitting the G color image light, and a liquid crystal panel 100B for converting blue (B) color illumination light into B color image light representing an image of a blue (B) color component and emitting the B color image light. The liquid crystal panels 100R, 100G, and 100B are arranged to respectively face three light-entering faces 105R, 105G, and 105B of a cross dichroic prism 105.

The cross dichroic prism 105 functions as a color light combining optical system that combines the respective color image lights entering from the respective liquid crystal panels 100R, 100G, and 100B and emits composite image light from a light-emitting face 105RGB.

The luminance adjustment device 150 and the projection optical system 120 are located downstream the cross dichroic prism 105 to be arranged in this order along a straight pathway of the composite image light emitted from the light-emitting face 105RGB of the cross dichroic prism 105.

The luminance adjustment device 150 regulates the transmittance of the composite image light emitted from the light-emitting face 105RGB of the cross dichroic prism 105 to adjust the luminance of a resulting image projected by the projection optical system 120. One typical example of the luminance adjustment device 150 having the luminance adjustment functions is a transmissive liquid crystal panel.

Illumination light emitted from a light source unit 111 included in the illumination optical system 110 is separated by a color light separating optical system (not shown) into the R, G, and B color illumination lights, which enter the corresponding liquid crystal panels 100R, 100G, and 100B.

A2. Detection of Motion Area

The motion area detection module 60 detects a motion area as described below.

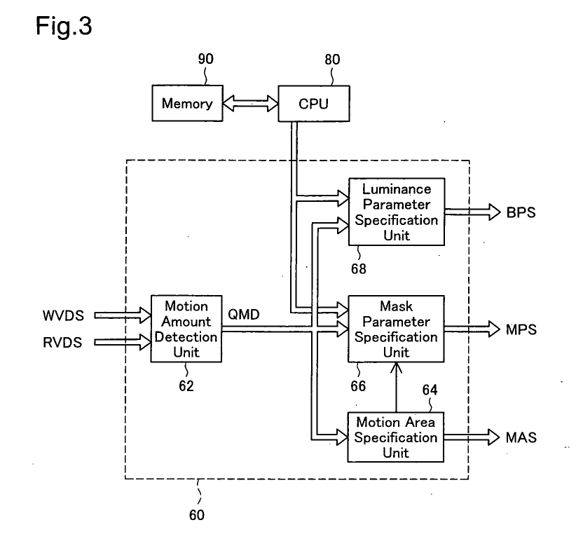

FIG. 3 is a block diagram showing the structure of the motion area detection module 60. The motion area detection module 60 includes a motion amount detection unit 62, a motion area specification unit 64, a mask parameter specification unit 66, and a luminance parameter specification unit 68.

The motion amount detection unit 62 respectively divides frame image data WVDS (object data) written in the frame memory 20 and frame image data RVDS (reference data) read from the frame memory 20 into rectangular pixel blocks of p×q pixels (where p and q are integers of not lower than 2). The motion amount detection unit 62 detects a motion vector between two continuous frames with regard to each pixel block and specifies the magnitude of the detected motion vector as a motion amount of each pixel block. Any of various known techniques is applicable to detect the motion vector and is thus not specifically described here. The specified motion amount is supplied as motion amount data QMD to the motion area specification unit 64, the mask parameter specification unit 66, and the luminance parameter specification unit 68.

The motion area specification unit 64 identifies a motion in each pixel block having the specified motion amount of not lower than a preset level and no motion in each pixel block having the specified motion amount of lower than the preset level and thereby specifies a motion area having some motion. The specified motion area is output as the motion area data MAS to the drive image data generation module 50 (see FIG. 1).

The mask parameter specification unit 66 specifies the value of the mask parameter MP corresponding to a motion amount Vm represented by the motion amount data QMD supplied from the motion amount specification unit 62. The specified value of the mask parameter MP is output as the mask parameter signal MPS to the drive image data generation module 50.

The mask parameter specification unit 66 stores in advance table data, which is read from the memory 90 and supplied by the CPU 80. The table data represents a variation in value of the mask parameter MP against the normalized motion amount Vm of the image. The mask parameter specification unit 66 refers to this table data and specifies the value of the mask parameter MP corresponding to the motion amount Vm represented by the supplied motion amount data QMD. The value of the mask parameter MP may not be based on the table data but may alternatively be obtained by a functional operation with an approximate polynomial expression.

Like the mask parameter specification unit 66, the luminance parameter specification unit 68 stores in advance table data, which is read from the memory 90 and supplied by the CPU 80. The table data represents a variation in value of the luminance parameter BP against the normalized motion amount Vm of the image. The luminance parameter specification unit 68 refers to this table data and specifies the value of the luminance parameter BP corresponding to the motion amount Vm represented by the supplied motion amount data QMD.

The value of the luminance parameter BP may not be based on the table data but may alternatively be obtained by a functional operation with an approximate polynomial expression.

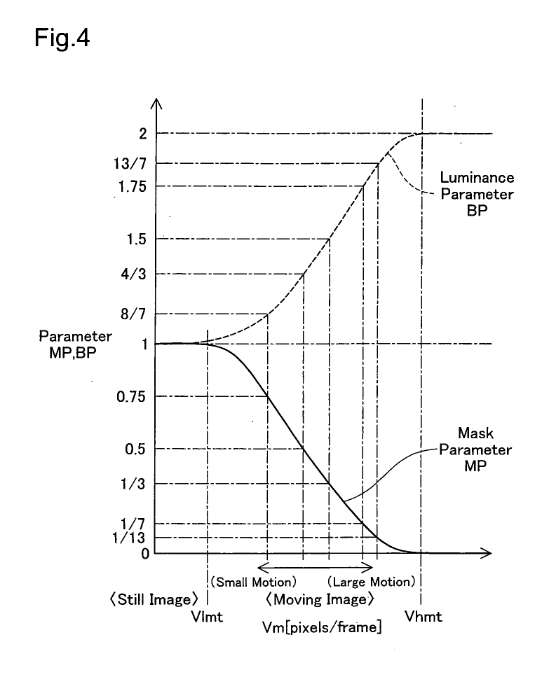

FIG. 4 shows one example of the table data stored in the mask parameter specification unit 66 and the luminance parameter specification unit 68. The table data shown in FIG. 4 represents a characteristic curve of the mask parameter MP (in a value range of 0 to 1) and a characteristic curve of the luminance parameter BP (in a value range of 1 to 2) against the motion amount Vm.

The motion amount Vm represents the number of pixels moving in each frame and is expressed as a moving speed in the unit of [pixels /frame]. The greater motion amount Vm reflects the larger motion in a moving image and is expected to damage the smoothness of display of the moving image. In the illustrated example of FIG. 4, the value of the mask parameter MP is set equal to ‘1’ upon identification of no motion when the motion amount Vm is not greater than a criterion value Vlmt. The value of the mask parameter MP decreases from ‘1’ with an increase in motion amount Vm upon identification of a motion when the motion amount Vm is greater than the criterion value Vlmt. The value of the mask parameter MP is set equal to ‘0’ when the motion amount Vm reaches or exceeds an upper limit Vhmt.

When the value of the mask parameter MP approaches to 0 with an increase in motion amount Vm, the effective luminance in a motion area included in a moving image becomes lower than the effective luminance in a non-motion area or a stationary area included in the moving image as described later. For each one-frame image identified as a moving image, the luminance parameter BP is set to have adequate values corresponding to a motion area and a stationary area. Based on such setting of the luminance parameter BP, the luminance adjustment device 150 adjusts the luminance of a displayed moving image to make the luminance in a motion area included in the moving image higher than the luminance in a stationary area included in the moving image. In the illustrated example of FIG. 4, the value of the luminance parameter BP increases from ‘1’ with an increase in motion amount Vm in a motion area of the moving image having the motion amount Vm of not smaller than the criterion value Vlmt. The value of the luminance parameter BP is set equal to ‘2’ when the motion amount Vm reaches or exceeds the upper limit Vhmt. The value of the luminance parameter BP is set equal to ‘1’ in a stationary area of the moving image having the motion amount Vm of smaller than the criterion value Vlmt. For each one-frame image identified as a stationary image, on the other hand, the value of the luminance parameter BP is fixed to ‘1’, like the stationary area included in the moving image. The relationship between the effective luminance of a displayed image and the luminance parameter BP will be described later in detail.

A3. Motion Compensation

The drive image data generation module 50 compensates the motion of the moving image as described below.

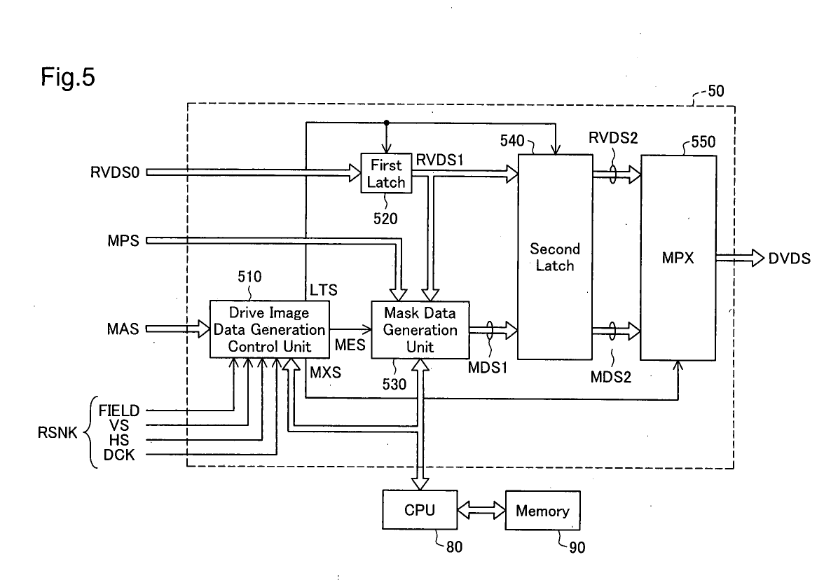

FIG. 5 is a block diagram showing the structure of the drive image data generation module 50. The drive image data generation module 50 includes a drive image data generation control unit 510, a first latch 520, a mask data generation unit 530, a second latch 540, and a multiplexer (MPX) 55.

The drive image data generation control unit 510 generates a latch signal LTS, a selection control signal MXS, and an enable signal MES, in response to a read vertical synchronizing signal VS, a read horizontal synchronizing signal HS, a read clock DCK, and a quasi-field selection signal FIELD included in the read synchronizing signal RSNK supplied from the memory read control module 40 (see FIG. 1), and the motion area data signal MAS supplied from the motion area detection module 60. The drive image data generation control unit 510 then outputs the latch signal LTS for controlling the operations of the first latch 520 and the second latch 540, the selection control signal MXS for controlling the operations of the multiplexer 550, and the enable signal MES for controlling the operations of the mask data generation unit 530, so as to control generation of the drive image data signal DVDS. The quasi-field selection signal FILED identifies whether the read image data signal RVDS0 read from the frame memory 20 at the double frame rate and supplied from the memory read control module 40 is a first read image data signal (read image data signal of a first quasi-field) or a second read image data signal (read image data signal of a second quasi-field).

The first latch 520 latches the read image data signal RVDS0 supplied from the memory read control module 40 in response to the latch signal LTS output from the drive image data generation control unit 510 and outputs the latched read image data as a read image data signal RVDS1 to the mask data generation unit 530 and the second latch 540.

With permission for generation of mask data by the enable signal MES supplied from the drive image data generation control unit 510, the mask data generation unit 530 generates mask data in response to the mask parameter signal MPS supplied from the motion area detection module 60 and the read image data signal RVDS1 supplied from the first latch 520. The mask data consists of pixel values determined in relation to pixel values of the read image data in the respective pixels. The generated mask data is output as a mask data signal MDS1 to the second latch 540. The enable signal MES gives permission for generation of the mask data to only the read image data of each detected motion area. The enable signal MES is generated in response to the read vertical synchronizing signal VS, the read horizontal synchronizing signal HS, the read clock DCK, and the motion area data signal MAS.

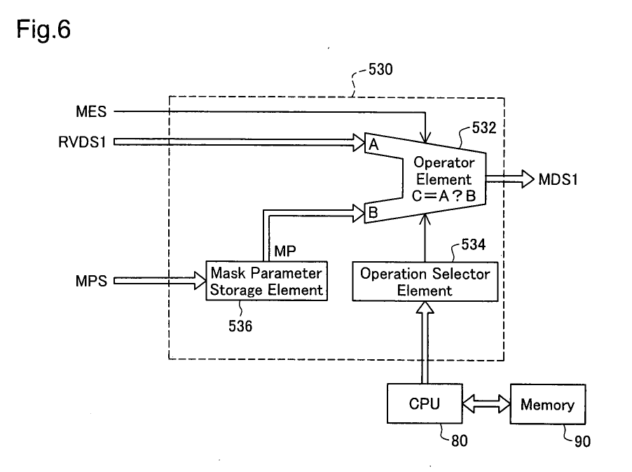

FIG. 6 is a block diagram showing the structure of the mask data generation unit 530. The mask data generation unit 530 includes an operator element 532, an operation selector element 534, and a mask parameter storage element 536.

The operation selector element 534 receives a mask data generation condition set in advance and stored in the memory 90 in response to a command from the CPU 80 and selectively sets an operation corresponding to the received mask data generation condition in the operator element 532. The operator element 532 is capable of performing various operations, for example, a multiplication and a bit shift operation. In this embodiment, a multiplication (C=A*B) is selectively set to be performed in the operator element 532.

The mask parameter storage element 536 stores data representing the value of the mask parameter MP specified by the mask parameter signal MPS supplied from the motion area detection module 60. In a stationary image or a stationary area included in a moving image, the data stored in the mask parameter storage element 536 represents the value ‘1’ of the mask parameter MP as shown in FIG. 4. In a motion area included in a moving image, the data stored in the mask parameter storage element 536 represents the value of the mask parameter MP varying in the value range of ‘1’ to ‘0’ with a variation in motion amount Vm as shown in FIG. 4. The value of the mask parameter MP stored in the mask parameter storage element 536 is supplied as an operation parameter B to the operator element 532.

With permission for an operation by the enable signal MES, the operator element 532 performs an operation (A?B: where ? denotes an operator of a selected operation) selected by the operation selector element 534 with read image data included in the input read image data signal RVDS1 as an operation parameter A and the mask parameter MP supplied from the mask parameter storage element 536 as the operation parameter B. Mask data representing an operation result C (=A?B) is then output as the mask data signal MDS1. With regard to the respective pixels in a motion area included in a moving image expressed by the input read image data RVDS1, the mask data corresponding to the motion amount of the motion area is accordingly generated based on the read image data of the respective pixels.

In one concrete example, it is assumed that the multiplication (C=A*B) is selectively set to be performed in the operator element 532, that a value ‘0.3’ of the mask parameter MP is supplied as the operation parameter B from the mask parameter storage element 536, and that the read image data included in the read image data signal RVDS1 and input as the operation parameter A includes pixel values ‘00h’, ‘32h’, and ‘FFh’. In this example, the operator element 532 outputs mask data of pixel values ‘00h’, ‘0Fh’, and ‘4Ch’ as the mask data signal MDS1. In another concrete example, when a value ‘0’ of the mask parameter MP is supplied as the operation parameter B, the operator element 532 outputs mask data of a pixel value ‘00h’ representing a minimum luminance level (black level) as the mask data signal MDS1.

In this embodiment, the multiplication is selectively set to be performed in the operator element 532, and the value of the mask parameter MP stored in the mask parameter storage element 536 varies in the range of ‘1’ to ‘0’ with a variation in motion amount as shown in FIG. 4. In another example, the bit shift operation may be selectively set to be performed in the operator element 532. In this case, the value of the mask parameter MP specified by the mask parameter specification unit 66 (see FIG. 3) represents a bit shift amount, and the table data or the function used by the mask parameter specification unit 66 is related to the bit shift amount. Namely the value of the mask parameter MP specified by the mask parameter specification unit 66 depends upon the operation selectively set to be performed in the operator element 532.

The second latch 540 (see FIG. 5) latches the read image data signal RVDS1 output from the first latch 520 and the mask data signal MDS1 output from the mask data generation unit 530 in response to the latch signal LTS and outputs the latched read image data as a read image data signal RVDS2 and the latched mask data as a mask data signal MDS2 to the multiplexer 550.

The multiplexer 550 selects one of the input read image data signal RVDS2 and the input mask data signal MDS2 in response to the selection control signal MXS output from the drive image data generation control unit 510, and outputs the selected signal as the drive image data signal DVDS to the liquid crystal panel actuating module 70 (see FIG. 1).

The selection control signal MXS is generated in response to the quasi-field selection signal FIELD, the read vertical synchronizing signal VS, the read horizontal synchronizing signal HS, the read clock DCK, and the motion area data signal MAS. The selection control signal MXS causes the mask data replaced by the read image data in the detected motion area to have a predetermined mask pattern.

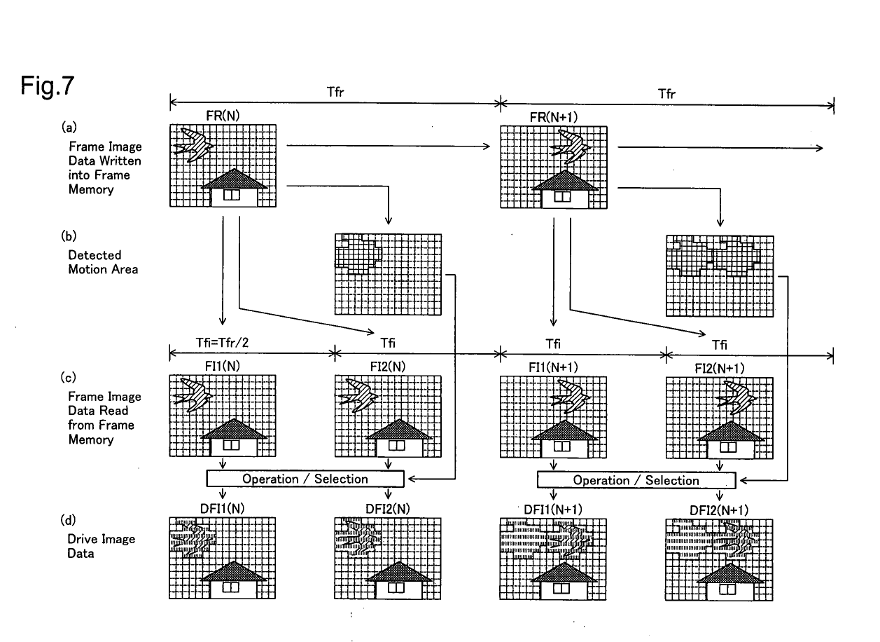

FIG. 7 shows one example of drive image data generated by the drive image data generation module 50. As shown in FIG. 7(a), frame image data of each frame is written in a fixed frame period Tfr into the frame memory 20 by the memory write control module 30 (see FIG. 1). In the illustrated example of FIG. 7(a), frame image data FR(N) of an N-th frame (where N is an integer of not less than 1) and frame image data FR(N+1) of an (N+1)-th frame are sequentially written into the frame memory 20.

The motion area detection module 60 (see FIG. 3) refers to the frame image data of FIG. 7(a) stored in the frame memory 20 and detects a motion area identified as an area with a motion relative to the previous frame image data of the previous frame as shown in FIG. 7(b). Each grid of the broken line in FIG. 7 represents a pixel block of p×q pixels, which is the detection unit of a motion vector by the motion amount detection unit 62 of the motion area detection module 60.

The memory read control module 40 (see FIG. 1) reads the frame image data of each frame from the frame memory 20 twice in the frame period Tfr, that is, once in each quasi-field period Tfi that is half the frame period Tfr, and sequentially outputs the two read-out frame image data as read image data FI1 of a first quasi-field and read image data FI2 of a second quasi-field as shown in FIG. 7(c). In the illustrated example of FIG. 7(c), the memory read control module 40 sequentially outputs read image data FI1(N) of a first quasi-field and read image data F12(N) of a second quasi-field in the N-th frame and read image data FI1(N+1) of a first quasi-field and read image data IF2(N+1) of a second quasi-field in the (N+1)-th frame.

The operation by the mask data generation unit 530 and the selection by the multiplexer 550 in the drive image data generation module 50 (see FIG. 5) replace part of the detected motion area in the read image data shown in FIG. 7(b) (an area defined by the broken line) with mask data generated by the mask data generation unit 530 and accordingly generate first drive image data DFI1 corresponding to the read image data FI1 of the first quasi-field and second drive image data DFI2 corresponding to the read image data F12 of the second quasi-field as shown in FIG. 7(d).

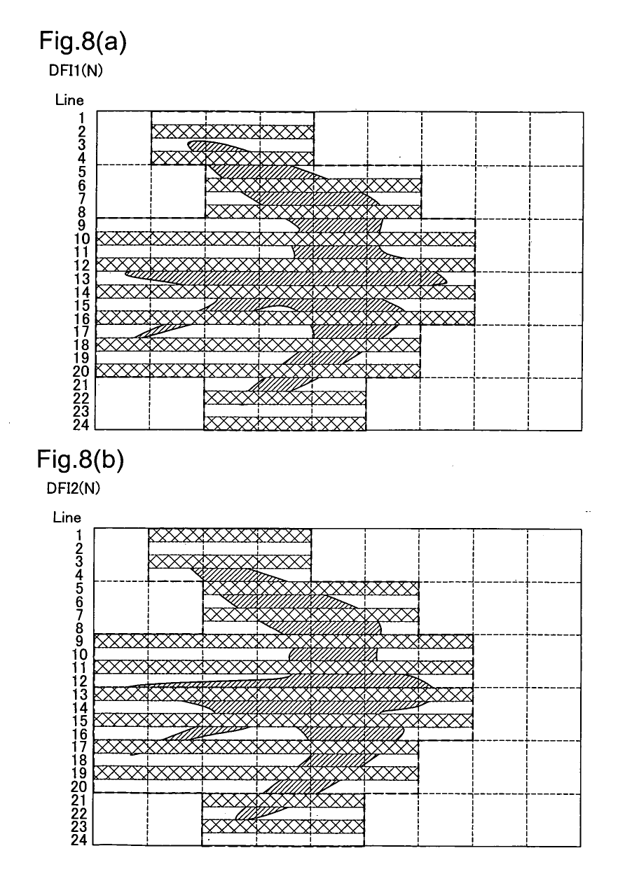

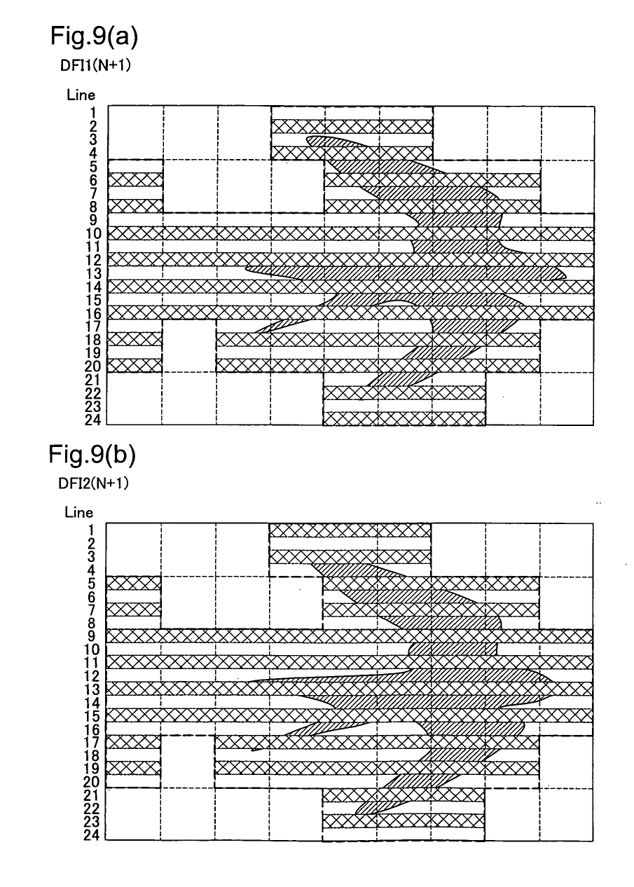

FIG. 8 shows motion areas of first drive image data DFI1(N) and second drive image data DFI2(N) generated corresponding to the frame image data FR(N) of the N-th frame. FIG. 9 shows motion areas of first drive image data DFI1(N+1) and second drive image data DFI2(N+1) generated corresponding to the frame image data FR(N+1) of the (N+1)-th frame. Each grid of the thin broken line represents a pixel block of p×q pixels, which is the detection unit of a motion vector. For the convenience of explanation and illustration, ‘p’ and ‘q’ are both equal to 4 pixels. An area defined by the thick broken line represents a detected motion area.

Replacement of even-numbered horizontal lines of the detected motion area in the read image data FI1(N) of the first quasi-field in the N-th frame with mask data (expressed by a cross hatched area) gives first drive image data DFI1(N) shown in FIG. 8(a). Replacement of odd-numbered horizontal lines of the detected motion area in the read image data F12(N) of the second quasi-field in the N-th frame with the mask data gives second drive image data DFI2(N) shown in FIG. 8(b).

Similarly replacement of even-numbered horizontal lines of the detected motion area in the read image data FI1(N+1) of the first quasi-field in the (N+1)-th frame with the mask data gives first drive image data DFI1(N+1) shown in FIG. 9(a). Replacement of odd-numbered horizontal lines of the detected motion area in the read image data FI2(N+1) of the second quasi-field in the (N+1)-th frame with the mask data gives second drive image data DFI2(N+1) shown in FIG. 9(b).

In the illustrated examples of FIGS. 8 and 9, the first drive image data DFI1 has the mask data replacing the even-numbered horizontal lines of the detected motion area, and the second drive image data DFI2 has the mask data replacing the odd-numbered horizontal lines of the detected motion area. This is, however, not restrictive and may be reversed. The first drive image data DFI1 may have mask data replacing the odd-numbered horizontal lines of the detected motion area, while the second drive image data DFI2 may have mask data replacing the even-numbered horizontal lines of the detected motion area.

In the illustrated examples of FIGS. 8 and 9, each one-frame image expressed by drive image data has only 16 pixel blocks in the horizontal direction and 12 pixel blocks in the vertical direction, that is, 64 pixels in the horizontal direction (equivalent to 64 vertical lines) and 48 pixels in the vertical direction (equivalent to 48 horizontal lines) and is shown as rather a discrete image. An actual frame image, however, has at least several hundred horizontal lines and vertical lines. Replacement of every other horizontal line with mask data lowers the brightness of a resulting image but is indistinctive by the human vision.

Read image data of a stationary image does not have any replacement with mask data. The read image data from the frame memory 20 is thus directly output as drive image data.

A4. Effects of Motion Compensation

As described above, the drive image data generation module 50 of this embodiment reads out the image data of each frame as read image data of a first quasi-field and read image data of a second quasi-field. A first drive image data signal is generated by replacing even-numbered horizontal lines of a detected motion area in the read image data of the first quasi-field with mask data. Similarly a second drive image data signal is generated by replacing odd-numbered horizontal lines of the detected motion area in the read image data of the second quasi-field with mask data. The motion compensation technique of this embodiment makes effective interpolation between two continuous quasi-fields in a motion area included in a moving image by taking advantage of the characteristics of the human vision, while maintaining the contrast and the picture quality of a stationary area included in the moving image. This desirably makes motion compensation to ensure a smooth motion in the moving image. The motion compensation technique also relieves the persistence of the human vision in the motion area and makes compensation to ensure a smooth motion. The motion compensation technique further controls the disturbance in color balance due to the persistence of the human vision in the motion area and makes compensation to give the favorable color balance.

The frame memory 20, the memory write control module 30, the memory read control module 40, and the drive image data generation module 50 of the embodiment are equivalent to the motion compensation module of the invention.

A5. Luminance Adjustment

The luminance adjustment device adjusts the luminance of a projected image, based on the luminance adjustment data signal BDS generated by the luminance adjustment data generation module 130 as described below.

The drive image data is generated for motion compensation by replacing the even-numbered horizontal lines of the detected motion area in the read image data of the first quasi-field with mask data and the odd-numbered horizontal lines of the detected motion area in the read image data of the second quasi-field with mask data. In a displayed one-frame image expressed by the read image data of the first quasi-field and the read image data of the second quasi-field, the image in a motion area is darker than the image in a stationary area. There is accordingly a luminance difference between the image in the motion area and the image in the stationary area in the displayed one-frame image, even when an original moving image to be displayed has a fixed luminance. The luminance difference may cause undesirably flicker. In the specification hereof, the luminance of an image represents the effective luminance of a one-frame image displayed according to the read image data of the first quasi-field and the read image data of the second quasi-field by taking advantage of the characteristics of the human vision.

In the image display apparatus DP1 of the embodiment, the luminance adjustment data generation module 130 generates and outputs the luminance adjustment data signal BDS to the luminance adjustment device 150 as described below. The luminance adjustment data signal BDS lowers the transmittance in a stationary area of the luminance adjustment device 150 corresponding to a stationary image or a stationary area included in a moving image than the maximum transmittance, while making the transmittance in a motion area of the luminance adjustment device 150 corresponding to a motion area included in the moving image higher than the transmittance in the stationary area of the luminance adjustment device 150. This effectively reduces a potential luminance difference between the motion area and the stationary area of the displayed moving image.

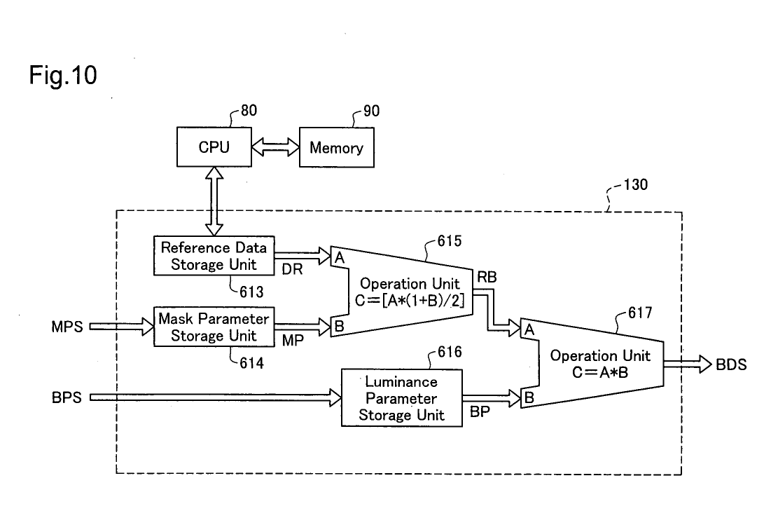

FIG. 10 is a block diagram showing the structure of the luminance adjustment data generation module 130. The luminance adjustment data generation module 130 includes a reference data storage unit 613, a mask parameter storage unit 614, an operation unit 615, a luminance parameter storage unit 616, and an operation unit 617.

The operation unit 615 performs an operation C=[A*(1+B)/2] with reference data DR stored in the reference data storage unit 613 as an operation parameter A and the value of the mask parameter MP for the motion area stored in the mask parameter storage unit 614 as an operation parameter B and generates reference luminance data RB given as:
RB=DR·(1+MP)/2 (1)

The reference luminance data RB represents the transmittance set in the stationary area of the luminance adjustment device 150 as a criterion of luminance adjustment in the luminance adjustment device 150. The ratio of the luminance in the motion area to the luminance in the stationary area included in the moving image, which is equivalent to a potential luminance difference in the displayed moving image, is substituted by the transmittance of the luminance adjustment device 150.

The reference data DR stored in the reference data storage unit 613 is set equal to a value that gives the transmittance ‘1’ of the luminance adjustment device 150. For example, when a data value ‘0’ and a data value ‘255’ respectively give the transmittance ‘0’ and the transmittance ‘1’ of the luminance adjustment device 150, the data value ‘255’ is set as the reference data DR in the reference data storage unit 613. The value of the mask parameter MP stored in the mask parameter storage unit 614 represents the motion amount in the motion area.

The operation unit 617 performs an operation C=[A*B] with the reference luminance data RB as an operation parameter A and the luminance parameter BP stored in the luminance parameter storage unit 616 as an operation parameter B and generates luminance adjustment data BD given as:
BD=RB·BP=[DR·(1+MP)/2]·BP (2)
The generated luminance adjustment data BD is supplied as the luminance adjustment signal BDS to the luminance adjustment device actuating module 140.

The luminance adjustment device 150 receiving the luminance adjustment data BD expressed by Equation (2) given above has a transmittance Tr expressed as:
Tr=BD/DR=[(1+MP)/2]·BP (3)

A concrete example of the luminance adjustment data BD is described below under condition that a motion area included in a moving image has the motion amount Vm of not smaller than the upper limit Vhmt as shown in FIG. 4 and the value of the mask parameter MP is equal to 0.

In this example, the reference luminance data RB is calculated as DR/2 according to Equation (1) given above. A stationary area included in the moving image has the motion amount Vm of not greater than the criterion value Vlmt and accordingly the luminance parameter BP equal to ‘1’ as shown in FIG. 4. Calculation of Equation (2) in this case gives the luminance adjustment data BD equal to DR/2, which is identical with the value DR/2 of the reference luminance data RB. A stationary area of the luminance adjustment device 150 corresponding to the stationary area in the moving image accordingly has a transmittance Trs equal to ‘½’ according to Equation (3) given above. A stationary image has no motion area and is equivalent to a moving image having only a stationary area. The luminance adjustment data BD and the transmittance Tr of the stationary image are calculated by Equations (2) and (3) given above.

The motion area included in the moving image has the luminance parameter BP of ‘2’ and the mask parameter MP of ‘0’ as shown in FIG. 4. Calculation of Equation (2) in this case gives the luminance adjustment data BD equal to DR, which is double the value DR/2 of the reference luminance data RB. A motion area of the luminance adjustment device 150 corresponding to the motion area in the moving image accordingly has a transmittance Trm equal to ‘1’ according to Equation (3) given above.

A6. Effects of Luminance Adjustment The adjustment of the transmittance of the luminance adjustment device 150 has the effects as described below.

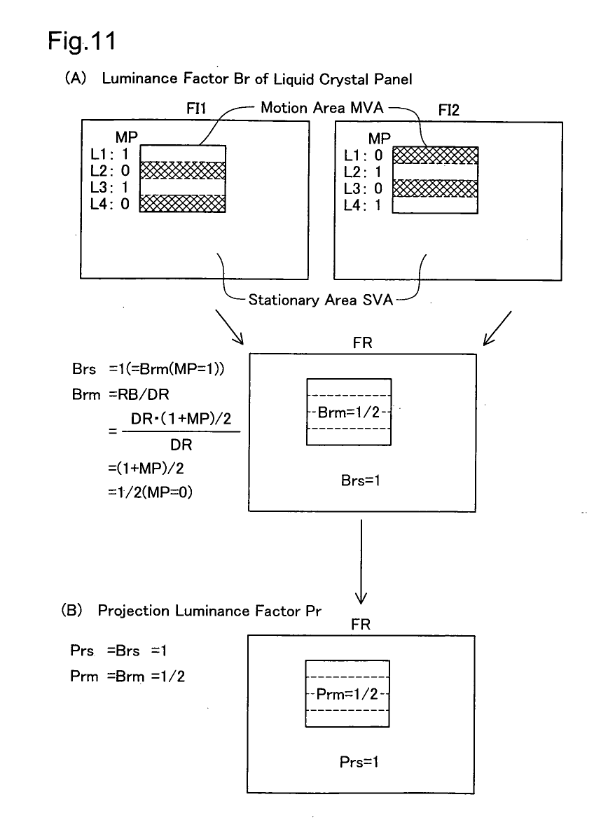

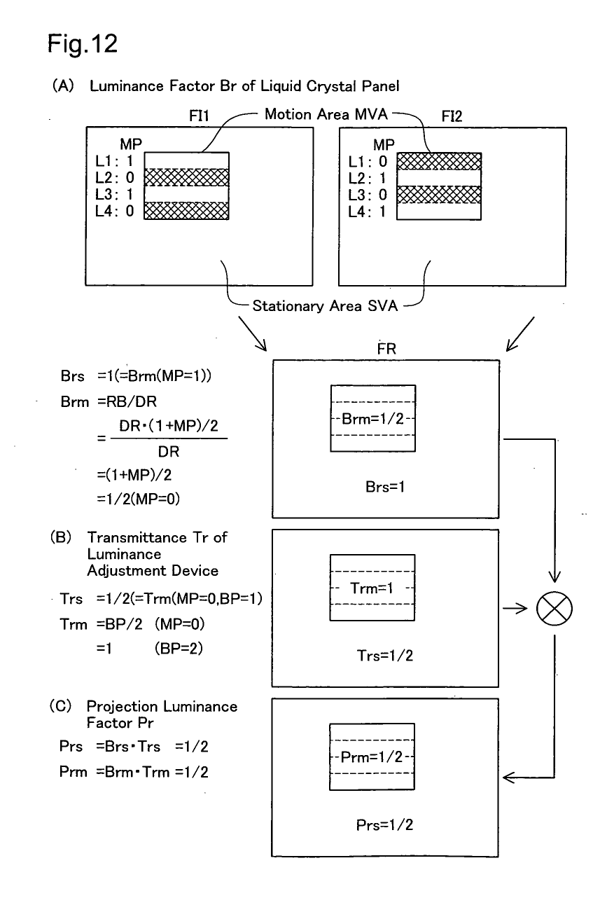

FIGS. 11 and 12 show the effects of luminance adjustment. FIG. 11 regards the luminance of a projected image without luminance adjustment, that is, in a conventional image display apparatus with no luminance adjustment device. The example of FIGS. 11 and 12 is on the premises that a motion area MVA included in a moving image has the motion amount Vm of not smaller than the upper limit Vhmt and the mask parameter MP equal to 0 and that the luminance parameter BP is equal to 2 in the motion area MVA and is equal to 1 in a stationary area SVA.

The drive image data of the motion area MVA includes mask data (cross-hatched area) replacing even-numbered horizontal lines of read image data in a first quasi-field FI1 and mask data replacing odd-numbered horizontal lines of read image data in a second quasi-field FI2 as described previously in the motion compensation (see FIG. 11(A)). The effective luminance of image light that is emitted from a liquid crystal panel and represents an image of one frame FR is expressed by a luminance factor Br relative to the luminance of the stationary area SVA. The stationary area SVA has a luminance factor Brs equal to ‘1’. The motion area MVA has a luminance factor Brm equal to ‘½’ against the mask parameter MP equal to ‘0’. The luminance factor Brm is calculated by Equation (4) given below:

$$\begin{matrix}Brm = RB / DR \\ = [ DR \cdot ( 1 + M ) / 2 ] / DR \\ = ( 1 + MP ) / 2\end{matrix} \qquad ( 4 )$$

The luminance factor Brs of the stationary area SVA is obtained by substituting the value ‘1’ of the mask parameter MP corresponding to the stationary area into the luminance factor Brm of the motion area MVA expressed by Equation (4) given above.

Each projected one-frame image has a projection luminance factor Pr relative to the luminance of the stationary area SVA. A projection luminance factor Prs of the stationary area and a projection luminance factor Prm of the motion area are respectively equal to the luminance factor Brs of the stationary area and the luminance factor Brm of the motion area on the liquid crystal panel. The stationary area and the motion area thus respectively have the projection luminance factor Prs equal to ‘1’ and the projection luminance factor Prm equal to ‘½’ as shown in FIG. 11(B).

There is accordingly a luminance difference between the image in the stationary area and the image in the motion area included in a displayed (projected) moving image, even when an original moving image to be displayed has a fixed luminance.

FIG. 12 regards the luminance of a projected image with luminance adjustment, that is, in the image display apparatus DP1 of the embodiment with the luminance adjustment device 150.

As in the conventional image display apparatus without luminance adjustment shown in FIG. 11, the stationary area and the motion area on the liquid crystal panel respectively have the luminance factor Brs equal to ‘1’ and the luminance factor Brm equal to ‘½’ in the image display apparatus DP1 of the embodiment with luminance adjustment as shown in FIG. 12(A).

The stationary area of the luminance adjustment device 150 corresponding to the stationary area SVA of the moving image has the transmittance Trs equal to ‘½’, while the motion area of the luminance adjustment device 150 corresponding to the motion area MVA of the moving image has the transmittance Trm equal to ‘1’ as shown in FIG. 12(B).

The projection luminance factor Pr of a projected one-frame image is expressed as the product of the luminance factor Br of the liquid crystal panel and the transmittance Tr of the luminance adjustment device 150:
Pr=Br·Tr (5)
The projection luminance factor Prs of the stationary area SVA and the projection luminance factor Prm of the motion area MVA are thus both equal to ‘½’ as shown in FIG. 12(C).

As described above, the luminance adjustment in the image display apparatus DP1 of the embodiment effectively eliminates the luminance difference, which arises between the motion area and the stationary area of the displayed moving image in the conventional image display apparatus without luminance adjustment, and thus prevents undesirable flicker.

The luminance adjustment data generation module 130, the luminance adjustment device actuating module 140, and the luminance adjustment device 150 of the embodiment are equivalent to the luminance adjustment module of the invention.

### B. Second Embodiment

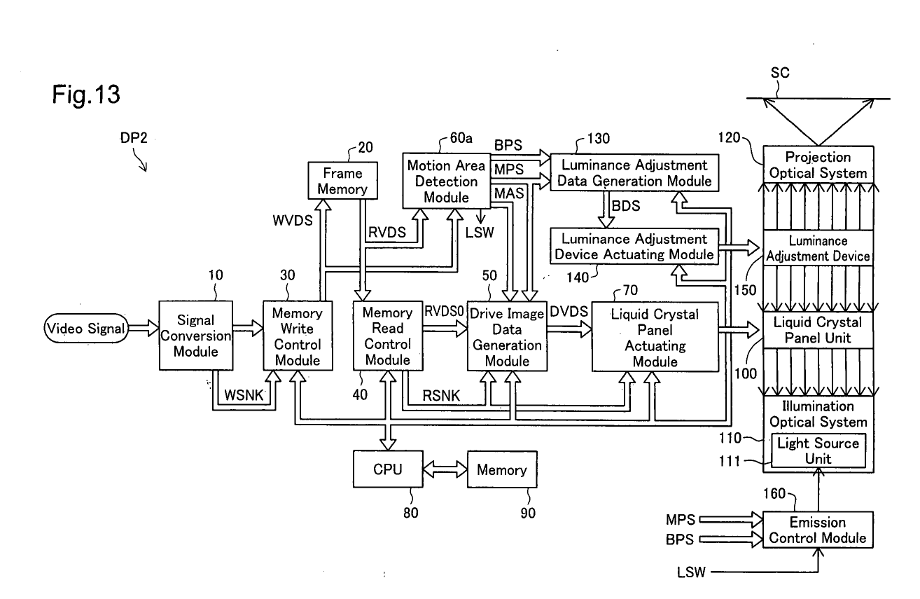

FIG. 13 is a block diagram schematically illustrating the configuration of another image display apparatus DP2 in a second embodiment of the invention. The image display apparatus DP2 of the second embodiment additionally has an emission control module 160, in addition to the constituents of the image display apparatus DP1 of the first embodiment shown in FIG. 1. The motion area detection module 60 of the first embodiment is replaced by a motion area detection module 60a that outputs an emission changeover signal LSW, in addition to the mask parameter signal MPS, the luminance parameter signal BPS, and the motion area detection signal MAS. The configuration of the image display apparatus DP2 of the second embodiment is otherwise identical with the configuration of the image display apparatus DP1 of the first embodiment.

The motion area detection module 60a has a motion amount detection unit, a motion area specification unit, a mask parameter specification unit, and a luminance parameter specification unit, like the motion area detection module 60 of the first embodiment shown in FIG. 3. The motion area specification unit has a function of outputting the emission changeover signal LSW to change over the emission amount of the light source unit 111 between a stationary image and a moving image expressed by the read image data signal RVDS from the frame memory 20, in addition to the function of the motion area specification unit 64 of the motion area detection module 60, that is, the function of outputting the motion area data signal MAS.

The emission control module 160 changes over the emission level of illumination light emitted from the light source unit 111 between display of a moving image and display of a stationary image, in response to the emission changeover signal LSW. An emission ratio Lr of the illumination light in display of a moving image to the illumination light in display of a stationary image is expressed as the reciprocal of a transmittance Trs set in a stationary area of the luminance adjustment device 150:
Lr=1/Trs (6)

For example, a motion area of a moving image having the motion amount Vm of not smaller than the upper limit Vhmt has the mask parameter MP equal to ‘0’ as shown in FIG. 4. A stationary area included in the moving image has the luminance parameter BP equal to ‘1’ as shown in FIG. 4. The transmittance Trs of the stationary area in the moving image is calculated to be ‘½’ by substitution of MP=0 and BP=1 in Equation (3) given above. The emission ratio Lr of the illumination light is calculated to be ‘2’ by substitution of the transmittance Trs=½ in Equation (6) given above. In this example, the emission control module 160 controls the emission level of the illumination light emitted from the light source unit 111 for display of the moving image to be double the emission level for display of the stationary image.

The emission control of the illumination light emitted from the light source unit 111 has the effects described below.

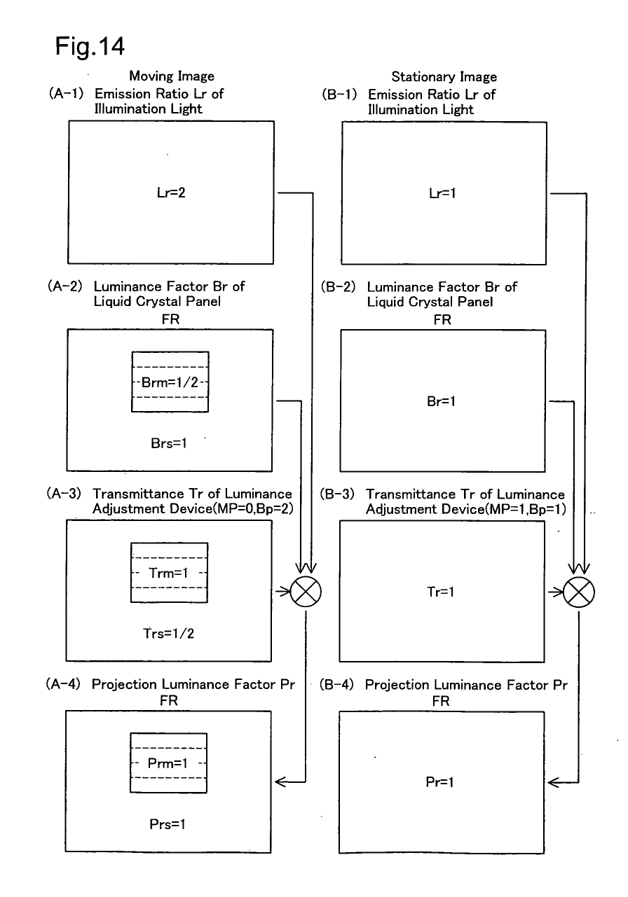

FIG. 14 shows the effects of luminance adjustment. FIGS. 14(A-1) through (A-4) show the effects in projection of a moving image, and FIGS. 14(B-1) through (B-4) show the effects in projection of a stationary image. As in the example of FIG. 12 showing the effects of the luminance adjustment of the first embodiment, the following description is on the premise that a motion area included in the moving image has the motion amount Vm of not smaller than the upper limit Vhmt and the mask parameter MP equal to 0.

The effects of the luminance adjustment in display of a moving image are described with reference to FIGS. 14(A-1) through (A-4).

A motion area in the moving image has the mask parameter MP equal to ‘1’ and the luminance parameter BP equal to ‘2’ as shown in FIG. 4. The emission ratio Lr of the illumination light for display of the moving image is set equal to ‘2’ (FIG. 14(A-1)).

As in the case of displaying the moving image in the first embodiment (see FIG. 12), a stationary area and a motion area on a liquid crystal panel respectively have the luminance factor Brs equal to ‘1’ and the luminance factor Brm equal to ‘½’ as shown in FIG. 14(A-2). In this example, the stationary area and the motion area on the luminance adjustment device 150 respectively have the transmittance Trs equal to ‘½’ and the transmittance Trm equal to ‘1’ as shown in FIG. 14(A-3).

The projection luminance factor Pr of a projected one-frame image in display of the moving image is expressed as the product of the emission ratio Lr of the illumination light, the luminance factor Br of the liquid crystal panel, and the transmittance Tr of the luminance adjustment device 150:
Pr=Lr·Br·Tr (7)
The projection luminance factor Prs of the stationary area SVA and the projection luminance factor Prm of the motion area MVA are thus both equal to ‘1’ as shown in FIG. 14(A-4).

The effects of the luminance adjustment in display of a stationary image are described with reference to FIGS. 14(B-1) through (B-4).

The emission ratio Lr of the illumination light for display of the stationary image is set equal to ‘1’ (FIG. 14(B-1)). The luminance factor Br of the stationary image on the liquid crystal panel is identical with the luminance factor Brs of the stationary area in the moving image and is equal to ‘1’ as shown in FIG. 14(B-2). In this example, the transmittance Tr of the luminance adjustment device 150 is equal to ‘1’ as shown in FIG. 14(C).

The projection luminance factor Pr of a projected one-frame image in display of the stationary is also expressed as the product of the emission ratio Lr of the illumination light, the luminance factor Br of the liquid crystal panel, and the transmittance Tr of the luminance adjustment device 150 according to Equation (7) given above and is equal to ‘1’ as shown in FIG. 14(D).

In the example of the first embodiment shown in FIG. 12, the projection luminance factor Prs of the stationary area and the projection luminance factor Prm of the motion area in the moving image are both equal to ‘½’. In the example of the second embodiment shown in FIG. 14, on the other hand, the projection luminance factor Prs of the stationary area and the projection luminance factor Prm of the motion area in the moving image are both equal to ‘1’. The luminance adjustment of the first embodiment lowers the overall display brightness to eliminate the luminance difference between the motion area and the stationary area, while the luminance adjustment of the second embodiment eliminates the luminance difference between the motion area and the stationary area without lowering the overall display brightness.

The luminance adjustment of the first embodiment may exert the similar effects to those of the luminance adjustment of the second embodiment by keeping the emission level of the illumination light twice the emission level in the conventional image display apparatus without luminance adjustment. In this case, however, the transmittance Tr of the luminance adjustment device 150 is lowered in display of the stationary image, like display of the stationary area in the moving image. This undesirably wastes a large potion of the illumination light emitted from the light source unit 111 and lowers the efficiency of power consumption.

The luminance adjustment of the second embodiment, however, sets the transmission factor Tr of the luminance adjustment device 150 equal to ‘1’, the emission ratio Lr of the illumination light equal to ‘1’, and the projection luminance factor Pr of the displayed stationary image equal to ‘1’ as described above with reference to FIGS. 14(B-1) through (B-4). This ensures the efficient use of the illumination light emitted from the light source unit 111 and desirably saves the power consumption of the light source unit 111.

The light source unit 111 is preferably designed to control the high-speed changeover of the emission level at periods of each frame. The light source unit may have an LED (light emitting diode) as the emission source.

### C. Modifications

The embodiments discussed above are to be considered in all aspects as illustrative and not restrictive. There may be many modifications, changes, and alterations without departing from the scope or spirit of the main characteristics of the present invention. Some examples of possible modification are given below.

### C1. Modified Example 1

In the image display apparatuses DP1 and DP2 of the first and the second embodiments described above, a transmissive liquid crystal panel is used for the luminance adjustment device 150. The luminance adjustment device 150 is, however, not restricted to this example, but may be a DMD (Digital Micromirror Device, trademark by Texas Instruments), a reflective liquid crystal panel, or any other suitable reflective device. The DMD is a micromirror display element including a large number of micromirrors arranged corresponding to pixels. Regulation of the reflection angles of the respective micromirrors adjusts the reflection directions of light by the respective micromirrors to generate image light.

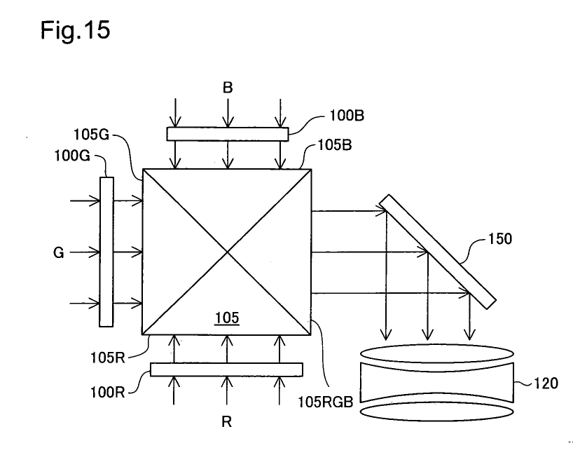

FIG. 15 shows one concrete arrangement of a reflective liquid crystal panel as the luminance adjustment device 150 in one modified example.

In the application of a transmissive liquid crystal panel to the luminance adjustment device 150, the luminance adjustment device 150 and the projection optical system 120 are arranged in this order along the straight pathway of the composite image light emitted from the light-emitting face 105RGB of the cross dichroic prism 105 as shown in FIG. 2. In the application of a reflective liquid crystal panel to the luminance adjustment device 150, on the other hand, the luminance adjustment device 150 is arranged to reflect the composite image light emitted from the light-emitting face 105RGB of the cross dichroic prism 105 in a direction different from the straight pathway of the composite image light, for example, in a direction substantially perpendicular to the straight pathway as shown in FIG. 15. The projection optical system 120 is arranged along the straight pathway of the composite image light reflected by the luminance adjustment device 150.

### C2. Modified Example 2

In the image display apparatuses DP1 and DP2 of the first and the second embodiments described above, the motion area specification unit 64 of the motion area detection module 60 specifies the luminance parameter BP corresponding to the detected motion amount Vm, based on the table data representing the variation in luminance parameter BP against the motion amount Vm as shown in FIG. 4. One modified structure may specify the luminance parameter BP, based on the motion amount Vm detected by the motion amount detection unit 62 and tone values YR, YG, and YB (corresponding to the luminance values) of the respective color components R, G, and B.

In this modified example, the luminance parameter BP is expressed as the product of a first luminance parameter BP1 corresponding to the motion amount Vm and a second luminance parameter BP2 corresponding to the tone values YR, YG, and YB of the respective color components R, G, and B:
BP=BP1·BP2 (8)

The first luminance parameter BP1 is equivalent to the luminance parameter of the first embodiment. The second luminance parameter BP2 represents an effect degree of the respective color components R, G, and B of a displayed image on the luminance of the displayed image and is expressed as:
BP2=KR·YR+KG·YG+KB·YB (9)

Here KR, KG, and KB denote coefficients representing effect degrees of the color components R, G, and B on the luminance. For example, KR=0.299, KG=0.587, and KB=0.114.

The luminance parameter BP of this modified example enables luminance adjustment with reflection of the potential effects of the respective color components R, G, and B of a displayed image on the luminance of the displayed image.

### C3. Modified Example 3

In the image display apparatuses DP1 and DP2 of the first and the second embodiments described above, the pixel values of the mask data are determined, based on the read image data and the value of the mask parameter MP corresponding to the motion amount Vm. In one possible modification, mask data may consist of pixel values representing a predetermined color image, for example, a black image or a grey image. In this modified example, the mask parameter MP and the luminance parameter BP have predetermined fixed values.

### C4. Modified Example 4

In the image display apparatuses DP1 and DP2 of the first and the second embodiments described above, the read image data and the mask data are alternately arranged on the horizontal lines. The read image data and the mask data may alternately be arranged on the vertical lines. The read image data and the mask data may alternately be arranged on the pixels in the horizontal direction or on the pixels in the vertical direction.

### C5. Modified Example 5

In the drive image data generation module 50 of the first and the second embodiments described above, the first latch 520 sequentially latches the read image data signal RVDS0 read from the frame memory 20 and supplied from the memory read control module 40. One modified structure may add a new frame memory before the first latch 520. In this structure, the read image data signal RVDS0 is written into the new frame memory, and the first latch 520 sequentially latches a new read image data signal read from the new frame memory. The motion area detection unit 60 receives the image data signal written in the new frame memory and the image data signal read from the new frame memory.

### C6. Modified Example 6

In the image display apparatuses DP1 and DP2 of the first and the second embodiments described above, mask data is generated for the individual pixels of the read image data. One modified procedure may generate mask data only for pixels of interest requiring replacement with the mask data. Any suitable procedure may be adopted to generate mask data corresponding to pixels of interest requiring replacement with the mask data and actually replace the pixels of interest with the generated mask data.

### C7. Modified Example 7

In the image display apparatuses DP1 and DP2 of the first and the second embodiments described above, the motion area detection module 60 includes the mask parameter specification unit 66 and the luminance parameter specification unit 68. The mask parameter specification unit 66 may alternatively be included in the drive image data generation module 50. The luminance parameter specification unit 68 may alternatively be included in the luminance adjustment data generation module 130. The motion area detection module 60, the drive image data generation module 50, and the luminance adjustment data generation module 130 may be integrated to one complex structure.

### C8. Modified Example 8

The above embodiments regard the projector including liquid crystal panels. The projector may include any of other various image display devices, for example, PDP (plasma display panels) or ELD (electroluminescence displays). The technique of the invention is applicable to projectors including DMD (Digital Micromirror Devices), as well as to direct vision image display apparatuses.

### C9. Modified Example 9

In the image display apparatuses DP1 and DP2 of the first and the second embodiments described above, the memory write control module, the memory read control module, the drive image data generation module, and the motion amount detection module are constructed as the hardware elements to generate the drive image data. At least part of these functional blocks may be actualized by the software configuration executed by the CPU according to a computer program.

Finally the present application claims the priority based on Japanese Patent Application No. 2005-195664 filed on Jul. 5, 2005, which is herein incorporated by reference.

What is claimed is:

1. An image display apparatus, comprising:
an image display device that sequentially displays frame images expressed by sequentially input frame image data;
a motion area detection module that sequentially detects a motion area in each of the sequentially displayed frame images;
a motion compensation module that performs motion compensation for the detected motion area of each frame image, generates drive image data with a result of the motion compensation, and outputs the drive image data to actuate the image display device; and
a luminance adjustment module that eliminates a luminance difference between the detected motion area and a stationary area in each frame image, which is ascribed to a decrease in luminance of the motion area relative to a luminance of the stationary area due to the motion compensation by the motion compensation module and potentially arises in the frame image displayed by the image display device,
wherein the motion compensation module comprises:
an image memory; and
a drive image data generation module that replaces at least part of read image data corresponding to the detected motion area, out of read image data sequentially read from the image memory, with mask data and generates the drive image data including the replaced mask data.

2. An image display apparatus in accordance with claim 1, wherein the luminance adjustment module comprises:
a luminance adjustment device that works to eliminate the luminance difference; and
a luminance adjustment data generation module that generates drive data for lowering a luminance of image light corresponding to the stationary area, out of image light emitted from the image display device to represent an image, to eliminate the luminance difference in each frame image and outputs the generated drive data to actuate the luminance adjustment device.

3. An image display apparatus in accordance with claim 2, the image display apparatus further comprising:
a light source that emits illumination light for illuminating the image display device; and
an emission control module that regulates an emission level of the light source,
wherein the emission control module increases the emission level of the light source to compensate for the lowered luminance of the image light corresponding to the stationary area by the luminance adjustment device, when the image displayed by the image display device has the motion area.

4. An image display apparatus in accordance with claim 1, wherein the motion compensation module specifies a pixel value of the mask data corresponding to a motion amount of the detected motion area and performs the motion compensation with the mask data of the specified pixel value, and
the luminance adjustment module eliminates the luminance difference, while preventing a significant decrease in luminance corresponding to the motion amount.

5. An image display apparatus in accordance with claim 2, wherein the motion compensation module specifies a pixel value of the mask data corresponding to a motion amount of the detected motion area and performs the motion compensation with the mask data of the specified pixel value, and
the luminance adjustment module eliminates the luminance difference, while preventing a significant decrease in luminance corresponding to the motion amount.

6. An image display apparatus in accordance with claim 3, wherein the motion compensation module specifies a pixel value of the mask data corresponding to a motion amount of the detected motion area and performs the motion compensation with the mask data of the specified pixel value, and
the luminance adjustment module eliminates the luminance difference, while preventing a significant decrease in luminance corresponding to the motion amount.

7. An image display apparatus, comprising:
an image display device that sequentially displays frame images expressed by sequentially input frame image data;
a motion area detection module that sequentially detects a motion area in each of the sequentially displayed frame images;
a motion compensation module that performs motion compensation for the detected motion area of each frame image, generates drive image data with a result of the motion compensation, and outputs the drive image data to actuate the image display device; and
a luminance adjustment module that eliminates a luminance difference between the detected motion area and a stationary area in each frame image, which is ascribed to a decrease in luminance of the motion area relative to a luminance of the stationary area due to the motion compensation by the motion compensation module and potentially arises in the frame image displayed by the image display device,
wherein the motion compensation module comprises:
an image memory;
a write control module that sequentially writes frame image data, which are successively input at a preset frame rate, into the image memory;
a read control module that reads the frame image data ‘s’ times from the image memory at a specific rate of ‘s’ times the frame rate, where ‘s’ represents an integer of not less than 2, with regard to each frame image data written in the image memory; and
a drive image data generation module that replaces at least part of read image data corresponding to the detected motion area, out of read image data sequentially read from the image memory, with mask data and generates the drive image data including the replaced mask data.
